(19) United States
(12) Patent Application Publication
(10) Pub. No.: US 2020/0232266 A1
(43) Pub. Date: Jul. 23, 2020

(54) Improvements in Movement Control Devices

(71) Applicant: Titus d.o.o. Dekani, Dekani (SI)

(72) Inventor: Shenggeng Qi, Shenzhen (CN)

(21) Appl. No.: 16/647,579

(22) PCT Filed: Sep. 28, 2018
(86) PCT No.: PCT/IB2018/001097

§ 371 Date: Mar. 16, 2020

(30) Foreign Application Priority Data
Sep. 29, 2017 (CN) 201710906901.0

(51) Int. Cl. E05F 5/10; E05F 5/08

(52) U.S. Cl. CPC E05F 5/10; E05F 5/08; E05Y 2900/132; E05Y 2201/686; E05Y 2201/264; E05Y 2900/20; E05Y 2201/21; E05Y 2201/256

(57) ABSTRACT

A movement control device is provided comprising a housing (11) with an elongate push rod (10) mounted therein for reciprocal movement along a longitudinal axis (x). One end of the push rod extends out of the housing. A spring (12) is arranged between the housing and the push rod to provide a biasing force on the push rod in a first direction parallel to the longitudinal axis. A damping device (15) is arranged between the housing and the push rod to provide a damped resistive force in a direction opposite to said first direction. An indexing mechanism (18) controls movement of the push rod relative to the housing. The damping device is arranged to act along an axis (y) that is parallel to the longitudinal axis of the push rod and spaced apart from it.

### FIELD OF THE INVENTION

This invention relates to movement control devices.

### BACKGROUND OF THE INVENTION

This invention relates to movement control devices for use in particular, though not exclusively, for furniture components such as drawers and doors.

### SUMMARY OF THE INVENTION

According to the invention there is provided a movement control device comprising a housing, an elongate push rod mounted in the housing for reciprocal movement along a longitudinal axis, with one end of the push rod extending out of the housing, a spring arranged between the housing and the push rod to provide a biasing force on the push rod in a first direction parallel to said longitudinal axis, a damping device arranged between the housing and the push rod to provide a damped resistive force in a direction opposite to said first direction, and an indexing mechanism for controlling movement of the push rod relative to the housing, with the damping device being arranged to act along an axis that is parallel to the longitudinal axis of the push rod and spaced apart from it.

### BRIEF DESCRIPTION OF THE DRAWINGS

By way of example, embodiments of the invention will now be described with reference to the accompanying drawings, in which:

FIGS. 1 and 2 show in sectional view a form of movement control device according to the invention in respectively its loaded and fully extended conditions, and

FIGS. 3 to 7 illustrate operation of the indexing mechanism of the device of FIGS. 1 and 2.

### DETAILED DESCRIPTION OF THE EMBODIMENTS OF THE INVENTION

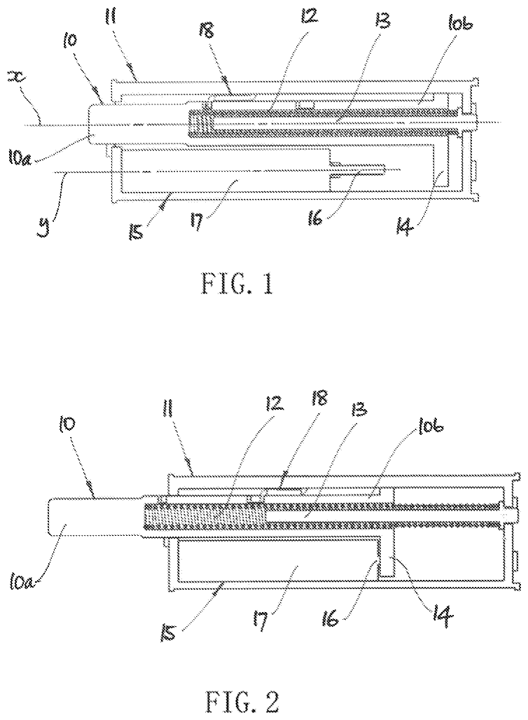

FIGS. 1 and 2 show a movement control device commonly known as a touch latch. Touch latches are typically used in furniture applications to assist with controlling movement of components such as drawers and doors. In particular, they facilitate opening and closing of such components by simply pushing on them in known manner.

The device seen in FIGS. 1 and 2 comprises an elongate push rod 10 which is mounted within a housing 11 for linear reciprocal movement along a longitudinal axis x. The push rod 10 has a hollow core in which is received a helical compression spring 12 and an elongate guide rod 13. The spring 12 seats between the push rod 10 and the housing 11 and serves to bias the push rod to extend out of the housing at its free end 10a. The guide rod 13 serves to guide the push rod 10 in its reciprocal movement.

At its inner end 10b, the push rod 10 has a flange 14. The flange 14 is designed to come into operative engagement with a damping device. It also serves to limit the extent of protrusion of the free end 10a of the push rod 10 out of the housing 11, although this could be achieved by other means.

The damping device here is in the known form of a linear piston and cylinder type damper 15, with a piston (not seen) connected to a piston rod 16 and mounted within a cylinder 17 containing damping fluid for linear reciprocal movement along a longitudinal axis y. The damper 15 is one that is designed to provide a damped resistive force on its compression stroke.

As seen in FIG. 1, the damper 15 is mounted in the housing 11 with its longitudinal axis y offset from the longitudinal axis x of the push rod 10 and parallel to it. This arrangement minimises the overall length of the device, which has the benefit of minimising the extent of intrusion of the device into the interior space of the furniture item in use.

The flange 14 on the push rod 10 is arranged to come into abutting engagement with the piston rod 16 of the damper 15 in the outward movement of the push rod, that is, as its free end 10a moves towards its most protruding position out of the housing 11. This actuates the damper 15 on its compression stroke.

Here, the damper 15 is one that is fitted with an internal spring arranged to bias the piston rod 16 towards its most protruding position. It would be possible to arrange for the piston rod 16 to be connected to the flange 14, in which case there would be no need for a spring in the damper 15. This would have the benefit of allowing room for a damper 15 with a longer working stroke. It will be appreciated that the damper 15 could alternatively be one with a working stroke in the opposite direction, ie upon its extension rather than its compression. In this case, the flange 14 and damper 15 would be arranged differently so that outward movement of the push rod 10 will cause an extension stroke of the damper.

It will be seen that in the loaded condition of the device, seen in FIG. 1, the flange 14 is spaced apart from the piston rod 16 of the damper 15. This means that the flange 14 will only move into abutting engagement with the piston rod 16 of the damper 15 after some initial outward movement of the to push rod 10. This initial movement of the push rod 10 will thus occur only under the biasing force of the spring 12.

Once the flange 14 has come into abutting contact with the piston rod 16 of the damper 15, the damper will then act to provide a damped resistive force to further outward movement of the push rod 10. With the housing 11 mounted in use on a drawer or door frame, the effect is for the push rod 10 to impart a two stage biasing force to the drawer or door in order to assist is opening, an initial spring force only stage and a subsequent damped spring force stage.

The damper 15 may be designed to produce resistive force over its working stroke at a constant rate. It may alternatively be designed to produce a variable rate of resistive force over its working stroke, for example to become progressively greater over the length of the stroke. The damper 15 may also be designed with a release at the end of its working stroke, ie a discontinuance of its damped resistive force. This will help to allow the diminishing biasing force of the spring 12 at that stage to cause full extension of the push rod 10.

FIG. 1 shows the device in its loaded condition, with the push rod 10 in its innermost position in the cylinder 11 and the spring 12 fully compressed. FIG. 2 shows the device in its fully extended condition, with the free end 10a of the push rod 10 in its most protruding position outside the cylinder 11, and the piston rod 16 of the damper 15 fully compressed.

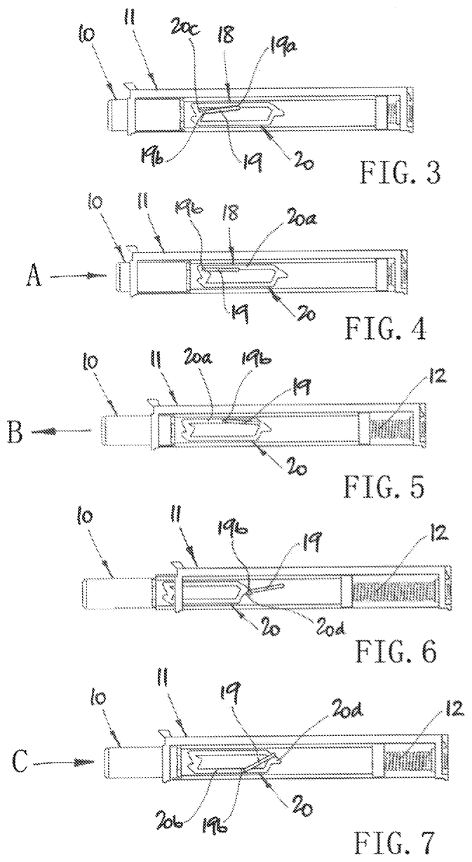

Movement of the push rod 10 in this device is governed by an indexing mechanism 18. The indexing mechanism 18 is seen in FIGS. 3 to 7 and is of a generally known kind comprising a latching pin 19 and a guide track 20. The latching pin 19 is of circular rod section bent into a generally known Z-shaped formation, with its ends extending perpendicularly in opposite directions to either side of its central portion. One of the ends 19a is engaged in a hole in the housing 11, which acts as a fulcrum for the latching pin 19 to pivot about. The other end 19b is engaged in the guide track 20, which is mounted on or forms part of the push rod 10. The guide track 20 is in the general shape of an elongate loop with straight sections 20a and 20b extending between latching pockets 20c and 20d.

FIG. 3 shows the indexing mechanism 18 with the device in its loaded condition, and here the push rod 10 is being held in its innermost position in the cylinder 11 by the latching pin 19 held by its end 19b in latching pocket 20c. This is the normal condition of the device when the drawer or door of the to furniture item is closed.

To open the drawer or door, a small pushing force is applied to it, producing a force on the push rod 10, illustrated by arrow A in FIG. 4. This causes the latching pin 19 to move along the guide track 20 towards its straight section 20a. This frees the push rod 10 to move out of the cylinder 11 under the biasing action of the spring 12. This movement of the push rod 10 is seen in FIG. 5 illustrated by arrow B.

The push rod 10 will continue to move out of the cylinder 11 until the latching pin 19 engages latching pocket 20d with its end 19b. This is the position illustrated in FIG. 6, which is the fully extended condition of the device. This is the condition that the device will be in when the drawer or door is open.

Closure of the drawer or door will re-set the device. This is seen occurring in FIG. 7, where closing movement of the drawer or door will impart a force on the push rod 10 illustrated by arrow C. This will cause the latching pin 19 to move along the guide track 20, with its end 19b coming out of engagement with latching pocket 20d and onto the straight section 20b. This movement will continue until latching pin 19 engages with its end 19b in latching pocket 20c, with the spring 12 now fully compressed, which is back to the loaded condition of the device seen in FIG. 3.

The device preferably incorporates a mechanism for adjusting the extent to which the push rod 10 protrudes out of the housing 11. For example, the push rod 10 may be provided with a screw-threaded end section to enable its overall length to be adjusted. This enables the device to be tailored to suit the furniture item in use, to ensure correct closure and opening movement of its drawer or door.

1. A movement control device comprising a housing, an elongate push rod mounted in the housing for reciprocal movement along a longitudinal axis, with one end of the push rod extending out of the housing, a spring arranged between the housing and the push rod to provide a biasing force on the push rod in a first direction parallel to said longitudinal axis, a damping device arranged between the housing and the push rod to provide a damped resistive force in a direction opposite to said first direction, and an indexing mechanism for controlling movement of the push rod relative to the housing, with the damping device being arranged to act along an axis that is parallel to the longitudinal axis of the push rod and spaced apart from it.

2. A device as claimed in claim 1 wherein the damping device is a linear damper.

3. A device as claimed in claim 2 wherein the damper is a piston and cylinder type damper.

4. A device as claimed in claim 2 wherein the linear damper is one that produces a damped resistive force at a constant rate over its working stroke.

5. A device as claimed in claim 2 wherein the linear damper is one that produces a variable damped resistive force over its working stroke.

6. A device as claimed in claim 5 wherein the damper is arranged so that the damped resistive force will cease at the end of its working stroke.

7. A device as claimed in claim 2 wherein the working stroke of the damper is on compression.

8. A device as claimed in claim 1 and further comprising a guide rod acting between the push rod and the cylinder to guide movement of the push rod.

9. A device as claimed in claim 8 wherein the spring is a compression spring.

10. A device as claimed in claim 9 wherein the compression spring is of helical form and fits over the guide rod.

11. A device as claimed in claim 1 wherein the push rod comprises a flange which is arranged to come into abutting engagement with the damping device.

12. A device as claimed in claim 11 and further comprising means to limit movement of the push rod out of the housing.

13. A device as claimed in claim 12 wherein the flange serves to limit said movement of the push rod out of the housing.

14. A device as claimed in claim 3 wherein the piston and cylinder type damper is one that produces a damped resistive force at a constant rate over its working stroke.

15. A device as claimed in claim 3 wherein the piston and cylinder type damper is one that produces a variable damped resistive force over its working stroke.

16. A device as claimed in claim 3 wherein the working stroke of the damper is on compression.

17. A device as claimed in claim 4 wherein the working stroke of the damper is on compression.

18. A device as claimed in claim 5 wherein the working stroke of the damper is on compression.

19. A device as claimed in in claim 6 wherein the working stroke of the damper is on compression.

20. A device as claimed in claim 1 and further comprising means to limit movement of the push rod out of the housing.
